(19) United States
(12) Patent Application Publication
(10) Pub. No.: US 2018/0144655 A1
(43) Pub. Date: May 24, 2018

(54) CONTENT SELECTION BASED ON PREDICTED PERFORMANCE RELATED TO TEST CONCEPTS

(71) Applicant: Hewlett-Packard Development Company, L.P., Fort Collins, CO (US)

(72) Inventors: Shanchan WU, Palo Alto, CA (US); Lei Liu, Palo Alto, CA (US)

(21) Appl. No.: 15/570,472

(22) PCT Filed: Jul. 29, 2015
(86) PCT No.: PCT/US2015/042614

§ 371 Date: Oct. 30, 2017

(51) Int. Cl. G09B 7/04; G09B 7/07; G09B 7/12; G09B 5/02

(52) U.S. Cl. CPC G09B 7/04; G09B 5/02; G09B 7/12; G09B 7/07

(57) ABSTRACT

Examples disclosed herein relate to content selection based on predicted performance related to test concepts. In one implementation, a processor selects a content element based on a comparison of associated predicted likelihood of improvement related to the test concepts and a correlation level to the test concepts. The processor may output information related to the selected content element.

### BACKGROUND

Students may answer test questions to evaluate their performance related to a set of test concepts. The test questions may be associated with, for example, text books self-test curriculum, classroom exams, standardized tests, self-learning evaluations, or career training assessments. In some cases, an educator may cover material related to the test concepts in a classroom setting, and the student performance associated with the test questions may be used to evaluate student progress.

### BRIEF DESCRIPTION OF THE DRAWINGS

The drawings describe example embodiments. The following detailed description references the drawings, wherein:

FIG. 1 is a block diagram illustrating one example of a computing system to select content based on predicted performance related to test concepts.

FIG. 2 is a flow chart illustrating one example of a method to select content based on predicted performance related to test concepts.

FIG. 3 is a block diagram illustrating one example of data inputs related to selecting content based on predicted performance related to test concepts.

FIGS. 4A-4E are diagram illustrating examples of selecting content based on predicted performance related to test concepts.

### DETAILED DESCRIPTION

In one implementation, a processor selects a content element for a user from a set of content elements based on a comparison of associated predicted likelihood of improvement related to test concepts in a set of test concepts and correlation levels between the selected content element and the test concepts. The processor may output information related to the selected content element such that it may be accessed by the user. The correlation level may indicate a degree to which the content element includes content used to answer a question related to the test concept. The processor may determine the predicted likelihood of improvement based on previous users and performance information related to the previous users. For example, some test concepts may be associated with improvement and/or high scores for students after accessing a content element, and other test concepts may have low improvement rates and/or low scores despite students accessing different sets of content elements. The processor may place greater weight on content elements with higher correlations to test concepts that show capability of higher scores/improvement because these test concepts may have a higher likelihood that preparing for the test concepts by accessing a content element may affect performance. The processor may further take into account the performance of the particular user, such as where more weight is given to test concepts whether the particular user scored more poorly and may want to focus on improvement.

Basing the performance prediction model on correlation information may allow for a faster method that uses information indicative of likelihood of a content element positively affecting performance instead of or in addition to data representing performance specifically associated with a particular content element. For example, a users performance related to a test concept after accessing a set of content elements may be attributed to particular content elements in the set at least partially based on the correlation level between the content element and the test concept.

A system that recommends a content element that is more likely to affect performance may be useful for formal education, informal learning, and career training. For example, a system that selects a content element to present based on predicted performance associated on a set of test concepts may be particularly valuable in the area of standardized testing. An educator may teach a set of concepts and then allow students to use software to test the students knowledge and present review material based on the test results. A system to select a content element based on likelihood of performance improvement may also be valuable for identifying review content, such as, in cases where a student has taken a course involving a set of content elements, and a processor automatically recommends which portions to review.

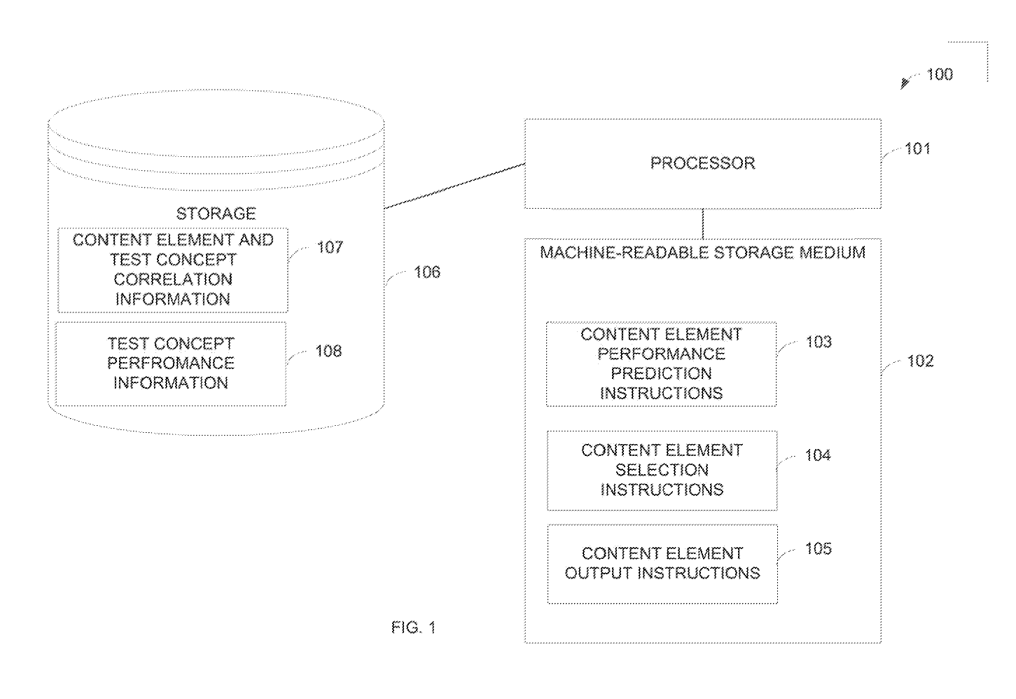

FIG. 1 is a block diagram illustrating one example of a computing system to select content based on predicted performance related to test concepts. For example, the computing system 100 may recommend a content element to a user based on the likelihood that accessing the content element will positively affect the users performance in relation to the set of test concepts. The computing system 100 includes a processor 101, a machine-readable storage medium 102, and a storage 106.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The storage 106 may be any suitable storage for storing information communicated with the processor 101. The processor 101 may communicate with the storage 106 directly or via a network. The storage 106 may store information used in determining the likelihood of accessing a content element will improve user performance related to a set of test concepts. For example, the storage 106 may store content element and test concept correlation information 107, and test concept performance information 108. The content elements may be any suitable content elements, such as elements of text, images, or video. The content elements may be any suitable division, such as based on chapter, page, or video frame set, The test concepts may be any suitable test concepts, such as concepts associated with a particular question, set of questions, and/or a topic associated with questions. The test concepts may be associated with multiple choice and/or open ended type questions.

The content element and test concept correlation information 107 may include information related to the degree to which material in a content element provides information used to answer a question associated with the test concept. The processor 101 or another processor may determine and store the correlation information. The correlation information may be determined in any suitable manner, such as based on distance within content between a test question related to the test concept to the content element, text similarity between the content element and test concept, concept similarity between the content element and the test concept, or educator input. The correlation levels may vary based on the test concept. For example, a first test concept may have a high correlation with a first content element and no correlation with a second content element, and a second test concept may have a low correlation with the first content element and a high correlation with the second content element.

The test concept performance information 108 may include previous user performance information related to the test concepts after previous user access to at least one of the content elements. The previous users may be associated with data related to previous content element access. In one implementation the test concept performance information 108 includes information about which content elements a user access and qualitative information about the access, such as amount of time or whether the navigation pattern was indicative of deep learning. The test concept performance information 108 may include information about a grade level, improvement amount, or other information indicating previous user performance after content element access.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium, The machine-readable non-transitory storage medium 102 may include instructions executable by the processor 101. For example, the machine-readable storage medium 102 may include content element performance prediction instructions 103, content element selection instructions 104, and content element output instructions 106.

The content element performance prediction instructions 103 may include instructions to predict performance associated with the content elements such that performance is predicted for a particular content element based on the test correlation levels to the content element and the performance information associated with the test concepts stored in the storage 106. For example, a performance prediction associated with a content element may be determined based on the likelihood and/or degree that performance associated with the test concept may he positively affected by accessing any, content elements and based on the correlation to the particular content element. The effect on performance may further take into account the particular user's previous performance such that test concepts where the user may improve are weighted as more important. A score or other ranking may be determined for the content element based on its predicted aggregate effect across the set of test concepts.

The content element selection instructions 104 includes instructions to select at least one of the content elements based on its relative predicted performance associated with the test concepts. For example, a content element may be selected based on a score above a threshold, a relative score, and/or a ranking in the top N or N % of content elements.

The processor may select a set of content elements based on user provided criteria. In one implementation, a user selects a target number or length of a set of content elements. In one implementation, the processor takes into account a target time frame for selecting the content element, such that the content element is associated with a study time less than the target time. The associated may be based on the number of words of other metric associated with the content element and/or previous user data related to the amount of time a user accessed the content element. The processor may select multiple content elements such that the study of the set of content elements is associated with a time frame within the target time frame.

The content element output instructions 105 may include instructions to output information related to the selected content element, such as by displaying, transmitting, or storing the information. The content element may be combined with other content and transmitted to a user. In one implementation, a print and/or digital compilation is created to include the selected content element.

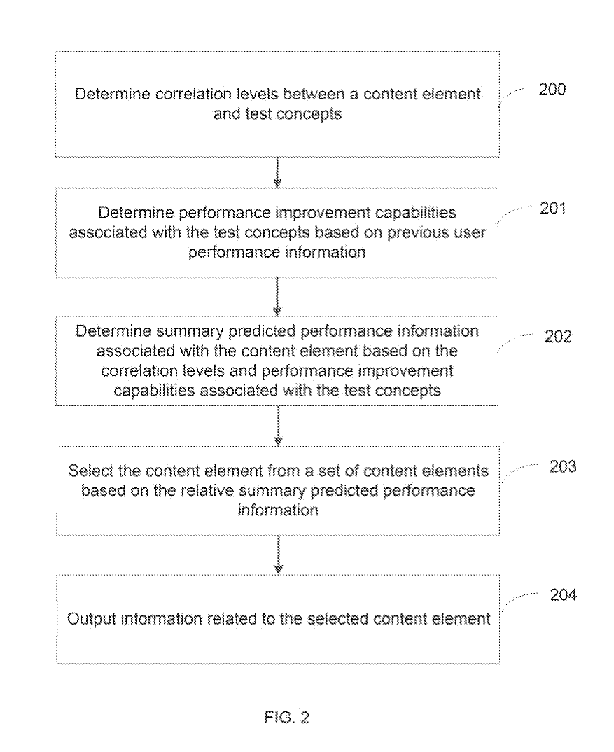

FIG. 2 is a flow chart illustrating one example of a method to select content based on predicted performance related to test concepts. For example, a processor lay determine a correlation level between a content element and a test concept, such as a correlation level indicative of the degree to which the content element covers content used to answer a question related to the test concept. The processor may further determine a predicted user performance related to the test concept associated with accessing the content element. For example, the processor may determine that previous users that accessed a set of material including the content element and/or accessed the content element for a particular amount of time had a predicted performance gain related to a test concept. The test concepts may be weighted such that test concepts that are associated with a greater performance gain are prioritized. The processor may select a content element for a user based on the test concept performance information and the correlation information between the content element and the test concepts. For example, the processor may select a content element with more correlation to test concepts associated with a greater possibility of a performance gain, such as where difficult test concepts that are not associated with a performance gain despite review of relevant content elements are given less priority. The method may be implemented, for example, by the processor 101 of FIG. 1.

Beginning at 200, a processor determines correlation levels between a content element and test concepts. The test concepts may be any concept that may be suitable for testing. The test concept may be represented by a specific question or a high level topic, and/or keywords.

The content elements may be any suitable elements of content, such as videos, images, or text. The content elements may be any suitable divisions of content, such as a chapter, page, video segment, or group of images. The content elements may be part of the same compilation or from different compilations. The content elements may include review content taken from main content, such as outlines, summaries, and main ideas from a text book created to be review content, where the review content is divided into content elements.

A processor may determine a correlation level between a content element and a test concept such that the content element has different correlation levels to different test concepts. In one implementation, a degree to which the content element provides information used to answer a question related to the test concept is used to determine the correlation level. The processor may determine the correlation based on term similarity, image similarity, concept similarity, topic similarity and/or other methods. The processor may determine information about the correlation level based on educator and/or student input, such as where an educator creates a test question and associates it with a content element. In one implementation, the processor determines the correlation level by accessing stored correlation information in a storage.

The processor may determine the correlation level based on a distance between a question associated with a test concept and a content element in a compilation. In one implementation, the distance between questions is determined to be a The processor may determine the correlation 1/D. The processor may further take into account similarity information, such as where the correlation is determined based on similarity*(1/D). In one implementation, the processor takes into account the total number of question such that the correlation is determined based on Q*(1/D)*similarity. The number of questions may be taken into account due to the fact that the greater number may mean more likelihood that the particular test question related to the test concept is related to the particular content adjacent to the test question in the compilation.

The processor may rank the correlation level and/or provide a specific correlation level score for each test concept and content element pair. In one implementation, the processor determines a correlation for a set of content elements and/or a set of test concepts. For example, a test concept may have a 0.70 correlation level with content element set A, B, and C, but higher summed individual correlation levels because some of the correlation may overlap subject matter for the same test concept.

Continuing to 201, a processor determines performance improvement capabilities associated with the test concepts based on previous user performance information. For example, the processor may determine the likelihood that spending time accessing content elements related to a test concept improved previous user performance in relate to the test concept, such as improvement compared to the users' own previous performance or performance compared to users that did not access content related to the test concept. The performance improvement capability information may be used to identify test concepts where performance is likely to benefit from increased study versus test concepts that are not. For example, some test concepts may be more difficult and less likely to show increased improvement despite increased effort. The processor may take into account the amount of time spent to increase performance related to a test concept, such as the amount of time spent on related material or the amount of different content elements correlated with the test concept accessed by a previous user.

The processor may use any suitable factors to determine the performance improvement capability of a test concept. For example, the processor may take into account the correlation between content elements reviewed by previous users and the test concept, the time spent by other users reviewing content elements, and the performance of the other users related to the test concept. The content elements may include both the content element being analyzed as well as other content elements with a correlation to the test concept. The correlation and time information may be used to infer the amount of study that a previous user did related to the test concept by accessing each of the content elements.

The content access information may be determined in any suitable manner, such as based, on a questionnaire or detection of digital access. In one implementation, the review information is represented as a binary value as to whether the content element was accessed. The information may include information related to the characteristics of the content element access, such as how long the content element was review, what type of review (e.g., in-depth reading vs. skimming), or other information indicative of the type of attention devoted to the content element.

The processor may determine the performance improvement capability related to multiple test concepts. In one implementation, the processor determines performance improvement capability in an aggregated manner, such as based on test concepts associated with a particular subject or topic.

Continuing to 202, a processor determines summary predicted performance information associated with the content element based on the correlation levels and performance improvement capabilities associated with the test concepts. For example, the summary predicted performance information may take into account predicted performance improvement capability associated with a set of test concepts related to accessing the content element. The content element may be associated with a high improvement capability related to a first test concept and a low likelihood of improvement related to a second test concept. The summary information may represent the overall likelihood of improvement associated with the contentment across the set of test concepts. The processor may take into account additional criteria related to the predicted performance related to a test concept in addition to the performance improvement capability, such as the likelihood of future test questions related to the test concept In one implementation, the processor determines performance improvement capability based on accessing a set of content elements. For example, the content elements in the set may address different test concepts such that together they are associated with a particular predicted performance.

In one implementation, the processor takes into account previous performance related to the specific test concepts associated with the particular user. For example, improvement capability may be prioritized for test concepts where the user performed more poorly and has more potential for improvement, such as where the user missed a previous question related to a test concept or took more tries to answer correctly. The improvement potential may be based on the amount of tries to get a correct answer, such as where there is greater improvement potential related to a missed question related to a test concept than to a question answered correctly related to a test concept on a third try.

Continuing to 203, a processor selects the content element from a set of content elements based on the relative summary predicted performance information. The processor may determine or access summary predicted performance information associated with other content elements, and compare to the summary predicted performance information associated with the content element. The processor may select the content element based on a threshold, top N comparison, and/or top N % comparison associated with the summary predicted performance information. In one implementation, the processor orders the content element in a compilation based on the relative summary predicted performance information, such as where content elements with greater predicted performance appear earlier in the compilation.

In one implementation, the processor selects a group of content elements based on summary information about their performance improvement capability. In one implementation, the processor takes into account efficiency, such as selecting shorter content elements, content elements associated with less access time from previous users, and/or fewer content elements that e associated L with he same or similar performance improvement capabilities.

In one implementation, the processor selects a content element based on expected review time, such as where a user provides a time frame for study, and the processor automatically selects a content element associated with a study time within the expected review time. In one implementation, the processor selects a set of content elements associated with a cumulative study time within the expected review time with a comparative higher performance improvement capability compared to other content element sets that are associated with a time frame within the expected review time. The amount of time associated with a content element may be determined by automatically analyzing the content element and/or accessing information related to previous user access time lengths.

In one implementation, the processor takes into account content elements previously accessed by the user, such as to present new content if the content element has been viewed more than a number of times above a threshold.

Continuing to 204, a processor outputs information related to the selected content element. The processor may transmit, store, or display information associated with the selected content element. The processor may output the information in the form of a recommendation to a user. The processor may output information related to a compilation including the content element, such as a print or digital compilation. The processor may cause information about the content element to be displayed such that a user may select the content element from a set of displayed content element options.

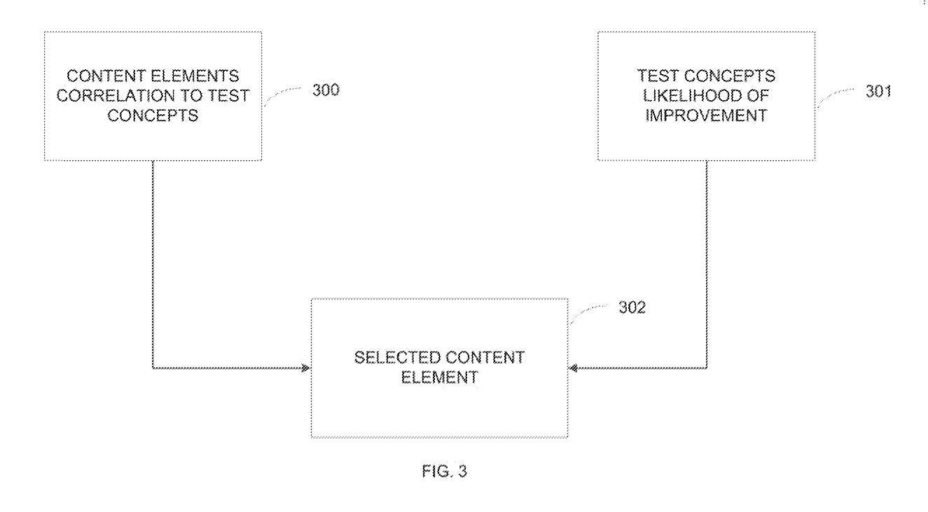

FIG. 3 is a block diagram illustrating one example of data inputs related to selecting content based on predicted performance related to test concepts. For example, a processor may select a content element to present a user based on a predicted efficiency of the content element in improving the user's performance.

Block 300 represents data including correlation information between content elements and test concepts. For example, the correlation information may represent the similarity between the learning concepts in the content element to the learning concepts associated with the test concept. The correlation information may be determined in any suitable manner, such as based on term similarity, concept similarity, distance between a question and content in a compilation, or other methods. The correlation information may be used in determining which content element is likely to improve user performance on a set of test concepts based on the overlap between the material in the content element and the material covered by the test concept.

Block 301 represents data including test concept likelihood of improvement. For example, a processor may compare previous user performance improvement on a test concept when accessing a set of content elements. The processor may aggregate the information across multiple previous users to determine a likelihood of improvement related to a test concept associated with multiple content elements and combinations. For example, some test concepts may show little improvement and/or low scores when associated with access to a variety of different content elements. These test concepts may be difficult and not worth studying content related to them because of the low expectation of success. Other concepts may show a higher likelihood of good and/or improved performance at least when associated with particular content elements.

Block 302 represents the selected content element based on the correlation and likelihood of improvement information. For example, a content element may be evaluated based on the overall likelihood of improvement associated with a test concept across multiple content elements compared to the correlation information to the particular content element. As a result, a content element is evaluated based on its overlap of material with the test concept and the likelihood that if the correct material is provided, the performance related to the test concept may be improved.

In one implementation, the processor takes into account a particular user's performance in selecting the content element. For example, the test concepts may be prioritized based on the amount that a user could improve, such as prioritizing test concepts where a user performed more poorly. Thus, test concepts that have a high likelihood of improvement are also compared to whether the user performance indicates that a user may improve in the area, versus already mastering the test concept.

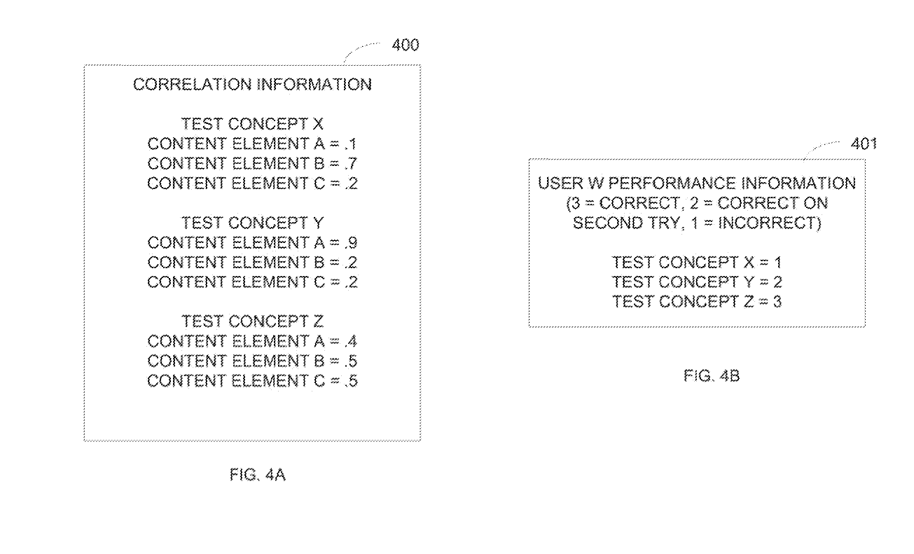

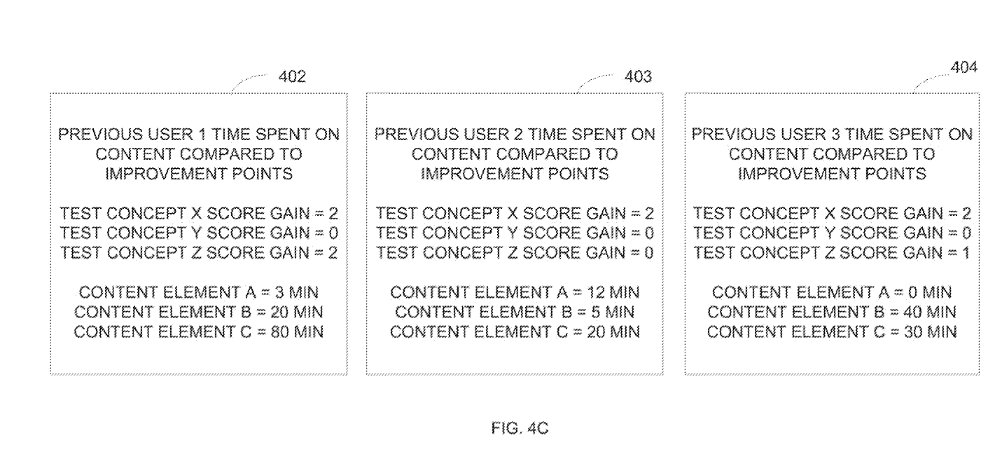

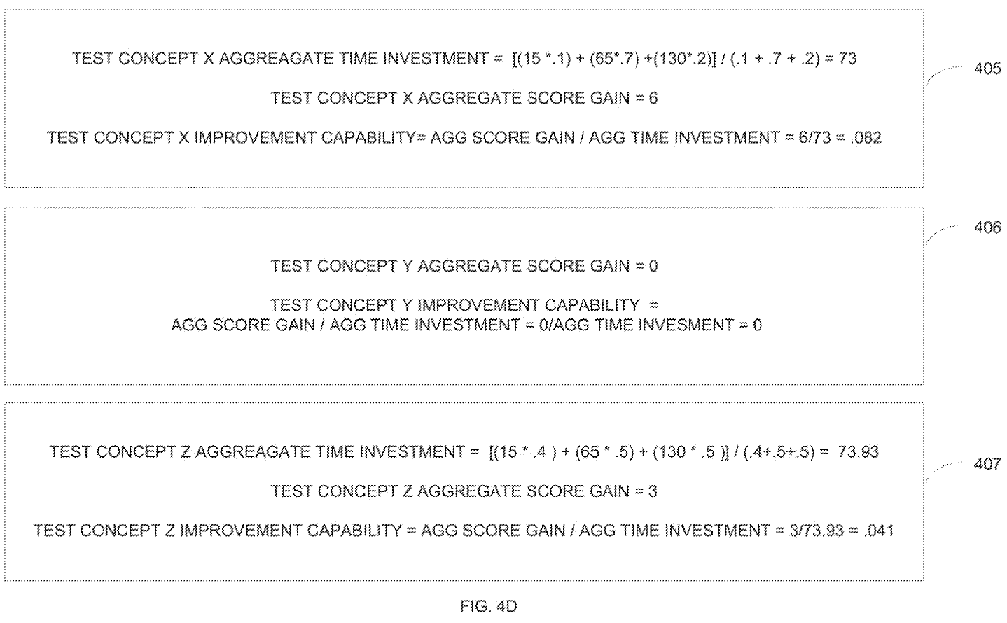

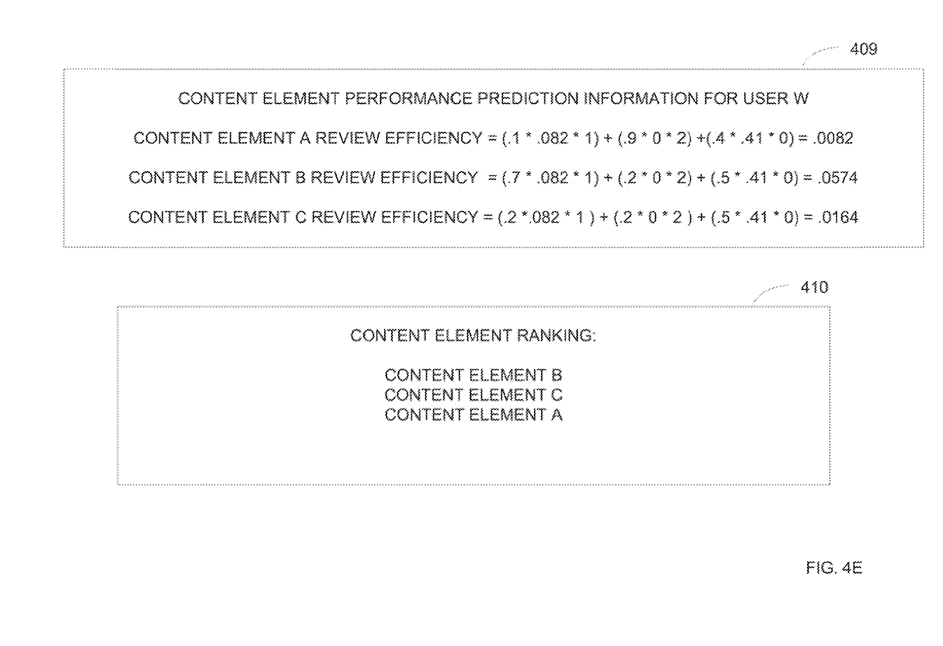

FIGS. 4A-E are diagrams illustrating one example of selecting review content based on likelihood of performance improvement. FIG. 4A is a diagram illustrating one example of correlation information between a content element and a test concept. Block 400 includes information about three test concepts, test concepts X, Y, and L and their correlation with three content elements, content elements A, B, and C. For example, test concept X has a 0.1 correlation with content element A, 0.7 correlation with content element B, and 0.2 correlation with content element C, showing that test concept X is more closely aligned with material covered in content element B. A test question related to test concept X may have a 0.7 probability of having the answer explained in content element B.

FIG. 4B is a diagram illustrating one example of past performance information associated with a user of a system requesting a content element recommendation. The past performance information accessed by a processor to select a content element may be related to answers to previous questions associated with a test concept, an overall grade or level associated with a test concept, or a number of tries to a correct answer to a test question associated with a test concept. Block 401 shows previous answer information of User W related to test concepts X, Y, and Z such that 3 points represents a correct answer, 2 points represents a correct answer on a second try, and 1 point represents and incorrect answer. User W got a question related to test concept Z right on a first try, and a question related to test concept Y correct on a second try. A software application may select a content element for User W based on User W's past performance and likelihood of improvement.

FIG. 3C is a diagram illustrating one example of previous user performance improvement associated with time spent on different content elements. A processor may take into account whether a content element was accessed and for how long to determine a likely level of improvement associated with a content element relative to a test concept. For example, user 1 spent 3 minutes on content element A, and afterwards had a score gain of 2 points related to test concept X, such as an improvement to 1 point from an incorrect answer to 3 points for a correct answer on a first try.

FIG. 4D is a diagram illustrating one example of determining a improvement capability related to a test concept based on time spent on content elements and associated score gain. For example, a processor may analyze the information from blocks 402, 403, and 404 from FIG. 4C. For example, block 405 shows a determination of an improvement capability related to test concept X, block 406 shows a determination of an improvement capability related to test concept Y, and block 407 shows a determination of an improvement capability related to test concept Z.

As an example, block 406 shows that the likelihood of improvement is determined based on the aggregate time investment across multiple previous users compared to the aggregate score gain across multiple previous users. The aggregate time investment takes into account the correlation between the test concept and the content element such that the time investment reflects that amount of time on material within the content element likely to be relevant to the test concept. Block 408 shows the aggregate time investment determined based on the sum of the correlation weighted by the time divided by the total of the correlation amounts, resulting in an improvement capability of 0.082. The improvement capability may be based on a test concept across the set of content elements such that test concepts that are unlikely to show Improvement despite review of content elements may be hard test concepts that are not worth spending as much time reviewing. Instead, a user may better off to focus on other test concepts that have a higher likelihood of improvement if the appropriate content element set is reviewed.

FIG. 4E is a diagram illustrating one example of selecting a content. element for a specific user to review in view of the user's past performance related to a set of test concepts and an improvement capability related to the test concepts. A processor may evaluate each content element to determine performance prediction information associated with the particular user for the set of test concepts. The performance prediction information may be based on the improvement capability associated with a test concept, the correlation of the content element to the test concept, and the users past performance related to the test concept. The performance prediction information is determined for each test concept and aggregated for the total performance prediction associated with the content element.

Block 409 shows content element performance prediction information for each of the content elements A, B, and C. For example, the performance prediction information for content A may be determined by a processor based on summarized information related to the, three test concepts. The second test concept Y does not affect the performance prediction because the improvement capability is 0, and the third test concept Z does not affect the performance prediction because the user W got an answer related to the test concept Z correct, leaving no room for improvement. The performance prediction for content element A is based on test concept X determined according to the correlation to content element A, the improvement capability associated with test concept X, and the improvement capability associated with user W.

Block 410 shows a ranking of content elements A, B, and C based on their relative review efficiency scores. For example, a processor may rank the content elements in order of content element B, content element C, and content element A based on their relative performance prediction information. The processor may select content element B to transmit or otherwise recommend to a user based on its highest ranking relative to the other content elements. In one implementation, user may review the content element, take a test related to the test concepts X, Y, and Z, and receive and updated recommendation based on the new information. Automatic selection of a content element based on its predicted effect on user performance may more efficiently improve user performance related to a set of test concepts.

1. A system, comprising:
a storage to store:
correlation levels between content elements and test concepts;
previous user performance information related t the test concepts after user access to at least one content element; and
a processor to:
predicted performance information associated with the content elements,
wherein the predicted performance information associated with a content element is determined based on the correlation levels between the test concepts and the content element and based on the performance information associated with the test concepts;
select at least one of the content elements based on the predicted performance information; and
output information related o the selected content element.

2. The computing system of claim 1, wherein selecting the at least one of the content elements comprises selecting the at least one of the content elements for a particular user further based on previous performance information related to the particular user.

3. The computing system of claim 2, wherein the previous user performance information comprises information related to at least one of: performance improvement after accessing a content element, the amount of time spent accessing a content element, and a navigation associated with the content element access.

4. The computing system of claim 1, wherein the processor is further to determine the correlation levels between the test concepts and the content elements, wherein determining a correlation between a test concept and a content element distance within content between a test question related to the test concept to the content element, text similarity between the content element and test concept, concept similarity between the content element and the test concept, and educator input.

5. The computing system of claim 1, wherein the processor is further to select the at least one of the content elements based on a target time frame and a time frame associated with the selected content element.

6. A method, comprising:
determining, by a processor, correlation levels between a content element and test concepts;
determining performance improvement capabilities associated with the test concepts based on previous user performance information;
determining summary predicted performance information associated with the content element based on the correlation levels and performance improvement capabilities associated with the test concepts;
selecting the content element from a set of content elements based on the relative summary predicted performance information; and
outputting information related to the selected content element.

7. The method of claim 6, wherein the content element is selected for a particular user and where selecting the content element further comprises selecting the content element based on previous performance of the particular user related to at least a subset of the test concepts.

8. The method of claim wherein selecting the content element based on previous performance of the particular user comprises selecting the content element based on at least one of: the number of tries for the user to answer a question related to a test concept correctly and the number of test questions related to a test concept answered incorrectly.

9. The method of claim 7, wherein determining summary predicted performance information comprises aggregating information related to test concept improvement capability, test concept correlation, and test concept user performance for each test concept as it relates to the content element.

10. The method of claim 6, wherein determining performance improvement capabilities associated with the test concepts based on previous user performance information comprises determining performance improvement capability for a test concept based on at least one of: which content elements previous users accessed, the length of time previous users accessed the content elements, and the number of tries for the previous users to answer a question related to the test concept correctly.

11. The method of claim 6, wherein determining a correlation between a test concept and a content element comprises determining the correlation based on at least one of: distance within content between a test question related to the test concept to the content element, text similarity between the content element and test concept, concept similarity between the content element and the test concept, and educator input.

12. The method of claim 6, further comprising selecting the content element based on an expected review time associated with the content element.

13. A machine readable non-transitory storage medium comprising instructions executable by a processor to:
select a content element for a user from a set of content elements based on a comparison of associated predicted likelihood of improvement related to test concepts in a set of test concepts and correlation levels between the selected content element and the test concepts; and
output information related to the selected content element.

14. The machine readable non-transitory storage medium of claim 13, further comprising instructions to select a subset of the content elements from which to select the content element based association of the subset of content elements to test concepts with performance by a user below a threshold.

15. The machine-readable non-transitory storage medium of claim 13, further comprising instructions to predict the likelihood of improvement associated with a test concept based on at least one of: past user performance, past performance associated with a plurality of other users, past content element access behavior associated with the user, and past content element access behavior associated with the plurality of other users.
